(19) United States
(12) Patent Application Publication
(10) Pub. No.: US 2026/0270615 A1
(43) Pub. Date: Sep. 10, 2026

(54) SOUND COLLECTING APPARATUS, STORAGE MEDIUM STORING PROGRAM, AND METHOD

(71) Applicant: KABUSHIKI KAISHA TOSHIBA, Kawasaki-shi (JP)

(72) Inventors: Akihiko ENAMITO, Kawasaki Kanagawa (JP); Takahiro HIRUMA, Tokyo (JP)

(73) Assignee: KABUSHIKI KAISHA TOSHIBA, Kawasaki-shi (JP)

(21) Appl. No.: 19/545,180

(22) Filed: Feb. 20, 2026

(30) Foreign Application Priority Data
Mar. 10, 2025 (JP) 2025-037737

(51) Int. Cl. H04R 3/00; H04R 1/40

(52) U.S. Cl. CPC H04R 3/005; H04R 1/406; H04R 2410/01; H04R 2430/01

(57) ABSTRACT

A sound collecting apparatus includes a processor including hardware. The processor selects one or more of two or more microphones as a reference microphone. The processor acquires a first acoustic signal from the reference microphone. The processor performs disturbance suppression processing including cross-correlation processing between the first acoustic signal and a second acoustic signal acquired from each of the microphones. The processor applies an acoustic filter to disturbance-suppressed acoustic signals from the respective microphones to impart sound pressure directivity toward a preset azimuth among a plurality of azimuths. The processor adds the acoustic signals to which the acoustic filter is applied. The processor outputs added acoustic signals that are obtained by the addition and are corresponding to the azimuths, respectively.

### CROSS-REFERENCE TO RELATED APPLICATION

This application is based upon and claims the benefit of priority from prior Japanese Patent Application No. 2025-037737, filed Mar. 10, 2025, the entire contents of which are incorporated herein by reference.

### FIELD

Embodiments described herein relate generally to a sound collecting apparatus, a storage medium storing a program, and a method.

### BACKGROUND

There is known a technique of detecting a position of an object by detecting, by using a microphone, a sound emitted from the object. In such a technology, in a case where there are a plurality of sound sources around the object, the microphone detects the surrounding sound in addition to the sound from the object. Such surrounding sound deteriorates the accuracy of the position estimation of the object. Although there are directional microphones having sound pressure sensitivity toward a specific direction, even a directional microphone has difficulty selectively collecting sound from a sound source at a specific position. Furthermore, the sound from the object is not necessarily large, and noise due to disturbance may be generated around the object. Even with the directional microphone, it is difficult to collect a small sound buried in noise.

An embodiment provides a sound collecting apparatus, a storage medium storing a program, and a method capable of collecting a sound of an object even in an environment where there is noise around the object.

### BRIEF DESCRIPTION OF DRAWINGS

FIG. 1 is a diagram showing an example of a configuration of a sound collecting apparatus according to a first embodiment.

FIG. 2 is a diagram showing an example of arrangement of microphones.

FIG. 3 is a diagram showing an example of a signal processing unit.

FIG. 4 is a diagram showing an example of a position estimation unit.

FIG. 5 is a diagram showing an example for describing a disturbance suppression processing.

FIG. 6A is a diagram showing an analysis result of coherence in an example of a case where the disturbance suppression processing is not performed.

FIG. 6B is a diagram showing an analysis result of coherence in an example of a case where the disturbance suppression processing is performed.

FIG. 7 is a diagram showing an analysis result of coherence in an example of a case where four reference microphones are selected and the disturbance suppression processing is performed.

FIG. 8 is a diagram showing an analysis result of the effect of the disturbance suppression processing compared for each frequency band.

FIG. 9A is a diagram showing a temporal change in an example of acoustic energy for each azimuth calculated under a condition that the disturbance suppression processing is not performed.

FIG. 9B is a diagram showing a temporal change of the estimation result of the position of an object based on the acoustic energy of FIG. 9A.

FIG. 10A is a diagram showing a temporal change in an example of acoustic energy for each azimuth calculated under a condition that the disturbance suppression processing has been performed.

FIG. 10B is a diagram showing a temporal change of the estimation result of the position of the object based on the acoustic energy of FIG. 10A.

FIG. 11 is a diagram showing a comparison of the level difference of the acoustic energy between the normal state and the abnormal state in a case where the result of FIG. 10A is obtained.

FIG. 12 is a diagram showing an example of a configuration of a sound collecting apparatus according to a second embodiment.

FIG. 13A is a diagram showing an analysis result of coherence in an example of a case where disturbance suppression processing is not performed.

FIG. 13B is a diagram showing an analysis result of coherence in an example of a case where the disturbance suppression processing including one cross-correlation process is performed.

FIG. 13C is a diagram showing an analysis result of coherence in an example of a case where the disturbance suppression processing including one cross-correlation process is performed where microphones 10R, 10U, 10L, and 10D are set as reference microphones.

FIG. 13D is a diagram showing an analysis result of coherence in an example of a case where the disturbance suppression processing including two cross-correlation processes is performed.

FIG. 14 is a diagram showing a modified example of the arrangement of microphones.

FIG. 15 is a diagram for describing selection of a reference microphone in consideration of spatial fluctuation or movement.

FIG. 16 is a diagram showing an example of a hardware configuration of the sound collecting apparatus.

### DETAILED DESCRIPTION

In general, according to one embodiment, a sound collecting apparatus includes a processor including hardware. The processor selects one or more of two or more microphones as a reference microphone. The processor acquires a first acoustic signal from the reference microphone. The processor performs disturbance suppression processing including cross-correlation processing between the first acoustic signal and a second acoustic signal acquired from each of the microphones. The processor applies an acoustic filter to disturbance-suppressed acoustic signals from the respective microphones to impart sound pressure directivity toward a preset azimuth among a plurality of azimuths. The processor adds the acoustic signals to which the acoustic filter is applied. The processor outputs added acoustic signals that are obtained by the addition and are corresponding to the azimuths, respectively.

Hereinafter, embodiments will be described with reference to the drawings.

### First Embodiment

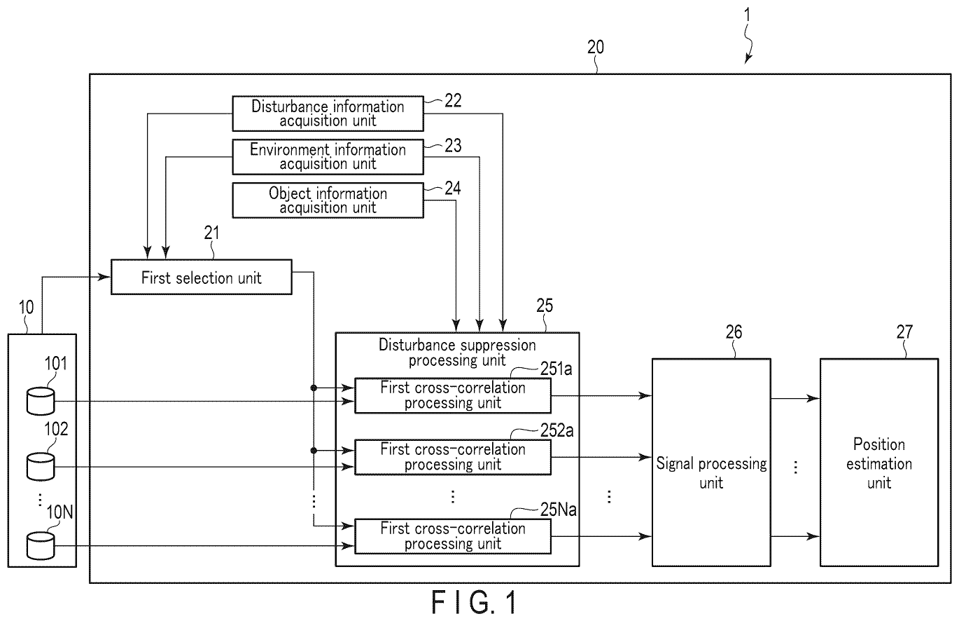

A first embodiment will be described. FIG. 1 is a diagram showing an example of a configuration of a sound collecting apparatus according to a first embodiment. A sound collecting apparatus 1 includes a microphone array 10 and a signal processing apparatus 20. The sound collecting apparatus 1 can be a sound collecting apparatus for estimating the position of an object that emits sound.

In the embodiment, by using the fact that the reciprocity theorem holds for a sound transmission system from a speaker to a spatial field and the sound transmission system from a sound source to a microphone, by applying a filter control law obtained in a gain control and an acoustic power minimization control using a plurality of speakers to the microphone sound collection system, a sensitivity control to artificially increase the sensitivity to the sound from a certain specific sensitized area around the microphone array 10 and an attenuation control to artificially reduce the sensitivity to the sound from an attenuated area other than the sensitized area are performed. In a case where the sound source is located in the sensitized area, only the sound from the sound source is collected with high sensitivity. Thereby, the exact position of the sound source can be estimated.

The gain control is control for increasing the sound pressure in a specific direction by controlling the amplitudes of sounds emitted from the speakers. On the other hand, the acoustic power minimization control is control for minimizing the acoustic power in a case where the speakers are viewed as one speaker by controlling the amplitudes and phases of the sounds emitted from the speakers. By using the gain control and the acoustic power minimization control in combination, a gradient of the sound pressure level is formed in a relatively narrow space around the speaker. The gradient of the sound pressure level allows the sound to be heard only in a specific area. In other words, the synthesized sound from the speakers has strong directivity. By using sensitivity control and attenuation control in combination based on the reciprocity theorem, sound is collected with a sound pressure sensitivity distribution similar to that of sound collection from a sound field in which a gradient of a sound pressure level is formed in a relatively narrow space around the microphones. In other words, the synthesized sound of the sounds collected by the microphones is equivalent to having strong directivity.

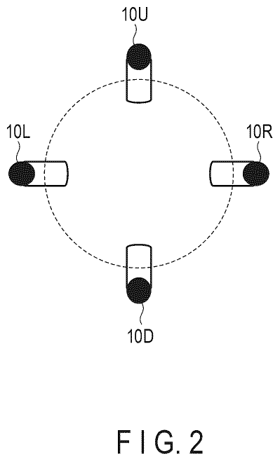

The microphone array 10 includes a plurality of microphones 101, 102, . . . , 10N (where N is an integer that is two or more) arranged close to each other. The microphones 101, 102, . . . , and 10N are devices that collect surrounding sound and convert the collected sound into an acoustic signal as an electric signal. For example, in a case where N is four, the microphone array 10 may include four microphones 10R, 10U, 10L, and 10D arranged on a circumference at 90-degree intervals, for example, at azimuth angles of 0 degrees, 90 degrees, 180 degrees, and 270 degrees, as shown in FIG. 2. FIG. 2 is a diagram of the four microphones viewed from above. At this time, for example, the microphone at the 0-degree azimuth may be a microphone located in the right direction if viewed from above, the microphone at the 90-degree azimuth may be a microphone located in the upper direction if viewed from above, the microphone at the 180-degree azimuth may be a microphone located in the left direction if viewed from above, and the microphone at the 270-degree azimuth may be a microphone located in the lower direction if viewed from above. Further, the microphones 10R, 10U, 10L, and 10D in FIG. 2 are outward microphones in which the microphone surfaces (black hatched portions) on which sound is incident face the outside of the circumference. The microphones 101, 102, . . . , and 10N may be integrally housed in a housing. Further, the microphones 101, 102, . . . , and 10N may be housed in the same housing as the signal processing apparatus 20.

The signal processing apparatus 20 performs signal processing on the acoustic signals obtained by the microphones 101, 102, . . . , and 10N, respectively. The signal processing apparatus 20 includes a first selection unit 21, a disturbance information acquisition unit 22, an environment information acquisition unit 23, an object information acquisition unit 24, a disturbance suppression processing unit 25, a signal processing unit 26, and a position estimation unit 27.

The first selection unit 21 selects a reference microphone from the microphones 101, 102, . . . , and 10N, and acquires an acoustic signal of the reference microphone. The reference microphone may be one or more microphones of the microphones 101, 102, . . . , 10N. The first selection unit 21 can select the reference microphone based on the disturbance information input from the disturbance information acquisition unit 22 and the environment information input from the environment information acquisition unit 23. The selection of the reference microphone will be described in detail later.

The disturbance information acquisition unit 22 acquires disturbance information as information on a sound source of a disturbance other than the sound of the object such as noise relative to the object. The disturbance information includes, for example, information on a position of a sound source of a disturbance in a space, information on a frequency characteristic of a sound emitted from a sound source of a disturbance, and the like. The disturbance information acquisition unit 22 can acquire the disturbance information based on, for example, an input from a user. Alternatively, the disturbance information acquisition unit 22 may be configured to acquire the disturbance information by measurement or analysis in advance.

The environment information acquisition unit 23 acquires environment information that is information on the environment of the space in which the sound collecting apparatus 1 is installed. The environment information includes information on a position in the space where the microphones 101, 102, . . . , and 10N are installed, a state of the space, for example, information on reverberation characteristics, and the like. The environment information acquisition unit 23 can acquire the environment information based on, for example, an input from the user. Alternatively, the environment information acquisition unit 23 may be configured to acquire the environment information by measurement or analysis in advance.

The object information acquisition unit 24 acquires object information that is information about the object. The object information includes information on frequency characteristics of a sound emitted from the object. The object information acquisition unit 24 can acquire object information based on, for example, an input from the user. Alternatively, the object information acquisition unit 24 may be configured to acquire the object information by measurement or analysis in advance.

The disturbance suppression processing unit 25 performs disturbance suppression processing for suppressing the influence of disturbance in the acoustic signals acquired by the microphones 101, 102, . . . , and 10N based on the acoustic signals acquired by each of the microphones 101, 102, . . . , and 10N and the acoustic signal of the reference microphone acquired by the first selection unit 21. The disturbance suppression processing includes cross-correlation processing between the acoustic signal of the reference microphone and the acoustic signal acquired by each of the microphones 101, 102, . . . , and 10N. For this purpose, the disturbance suppression processing unit 25 includes the same number of first cross-correlation processing units 251a, 252a, . . . , and 25Na as the number of microphones included in the microphone array 10, that is, N.

The acoustic signal of the reference microphone selected by the first selection unit 21 and the acoustic signals from the corresponding microphones of the microphones 101, 102, . . . , and 10N are input to the first cross-correlation processing units 251a, 252a, . . . , and 25Na. The first cross-correlation processing units 251a, 252a, . . . , and 25Na output a cross-correlation signal corresponding to a cross-correlation result between the two input acoustic signals as an acoustic signal after the disturbance suppression processing. For example, in a case where the reference microphone is the microphone 101, the first cross-correlation processing units 251a, 252a, . . . , and 25Na output the cross-correlation signal s_{cN} expressed by the following Equation (1).

$${s}_{c N} = ( {s}_{1} + {n}_{1} ) {( {s}_{N} + {n}_{N} )}^{*} = {s}_{1} {s}_{N}^{*} + {s}_{1} {n}_{N}^{⋆} + {n}_{1} {n}_{N}^{⋆} + {n}_{1} {n}_{N}^{⋆} = {s}_{1} {s}_{N}^{*} + {n}_{1} {n}_{N}^{*} \qquad Equation ( 1 )$$

In Equation (1), s₁ is a component of a sound source of the object in the acoustic signal of the microphone 101, and n₁ is a component of a sound source of a disturbance in the acoustic signal of the microphone 101. In addition, s_{N} is a component of a sound source of the object in the acoustic signal of the microphone 10N, and n_{N} is a component of a sound source of a disturbance in the acoustic signal of the microphone 10N. In addition, * represents a complex conjugate. As shown in Equation (1), among the right side four terms calculated by the cross-correlation processing, the s₁n_{N}* term and the n₁n_{N}* term are removed because they are uncorrelated. In this manner, the influence of the component of the disturbance is suppressed.

Here, the disturbance suppression processing unit 25 can perform the disturbance suppression processing other than the cross-correlation processing based on the disturbance information input from the disturbance information acquisition unit 22, the environment information input from the environment information acquisition unit 23, and the object information input from the object information acquisition unit 24. The disturbance suppression processing will be described in detail later.

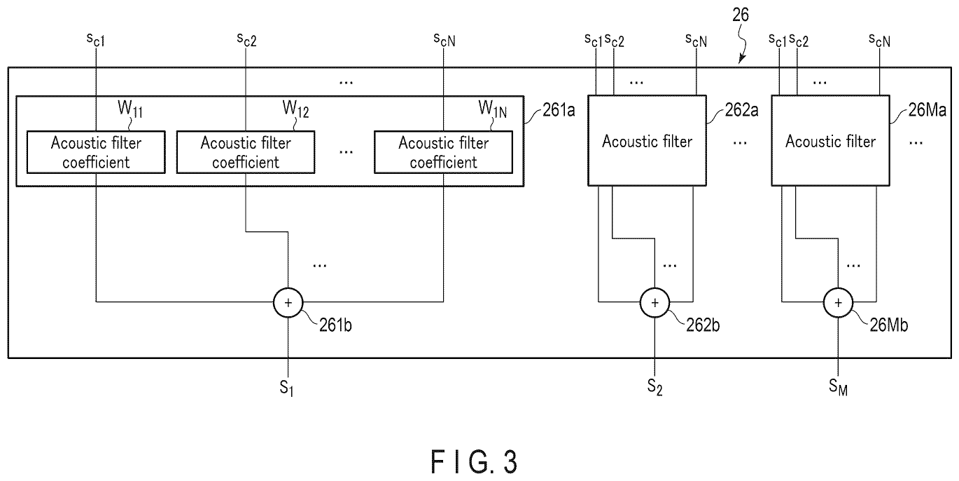

The signal processing unit 26 performs signal processing for the gain processing and the attenuation processing on the N acoustic signals after the disturbance suppression processing output from the disturbance suppression processing unit 25. As shown in FIG. 3, the signal processing unit 26 includes M (where M is an integer that is one or more) acoustic filters 261a, 262a, . . . , and 26Ma corresponding to the number of azimuths to be subjected to position estimation, and M adders 261b, 262b, . . . , and 26Mb.

Each of the acoustic filters 261a, 262a, . . . , and 26Ma is a filter including N acoustic filter coefficients W_{MN} corresponding to the number of acoustic signals after the disturbance suppression processing. The acoustic filters 261a, 262a, . . . , and 26Ma filter the N acoustic signals s_{c1}, s_{c2}, . . . , and s_{cN} after the disturbance suppression processing according to the corresponding filter coefficients. Then, the acoustic filters 261a, 262a, . . . , and 26Ma output N filtered acoustic signals. The acoustic filter coefficient of each of the acoustic filters 261a, 262a, . . . , and 26Ma can be determined based on the gain control law and the acoustic power minimization control law in a case where the control point of the gain control is set at the azimuth corresponding to the target of each position estimation. The detailed explanation regarding the derivation method of the acoustic filter coefficient will be omitted.

The adders 261b, 262b, . . . , and 26Mb are provided corresponding to the acoustic filters 261a, 262a, . . . , and 26Ma. The adders 261b, 262b, . . . , and 26Mb add the N acoustic signals output from the corresponding acoustic filters. Then, the adders 261b, 262b, . . . , and 26Mb output the added acoustic signals S₁, S₂, . . . , and S_{M}. The sound pressure distribution of the added acoustic signal generated by synthesizing the N acoustic signals convoluted with the acoustic filter determined based on the gain control law and the acoustic power minimization control law exhibits strong directivity toward the azimuth corresponding to the target of position estimation.

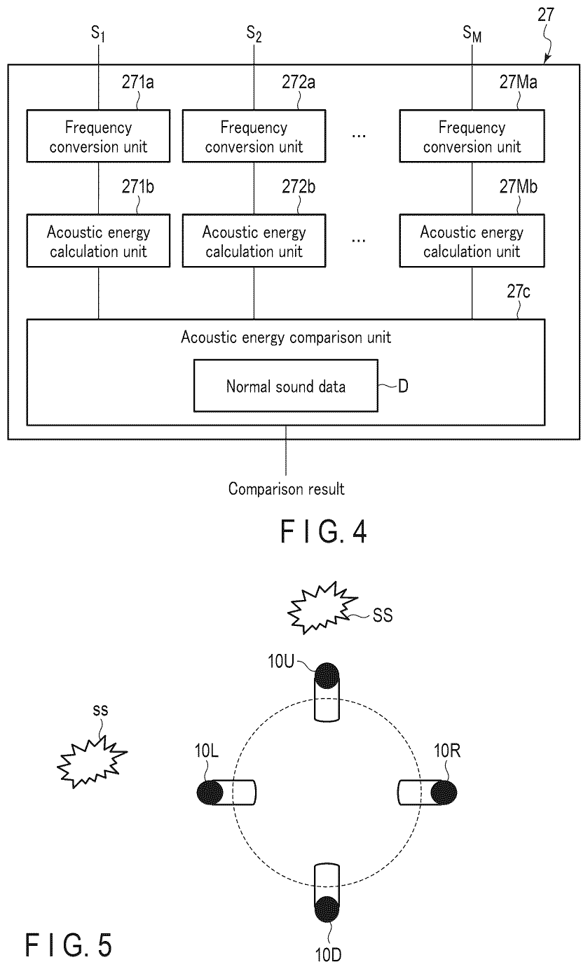

The position estimation unit 27 estimates the position of the object using the acoustic signal processed by the signal processing unit 26. As shown in FIG. 4, the position estimation unit 27 includes M frequency conversion units 271a, 272a, . . . , and 27Ma corresponding to the number of added acoustic signals S₁, S₂, . . . , and S_{M}, M acoustic energy calculation units 271b, 272b, . . . , and 27Mb, and an acoustic energy comparison unit 27c.

The frequency conversion units 271a, 272a, . . . , and 27Ma respectively convert the M added acoustic signals S₁, S₂, . . . , and S_{M}, which are time-domain signals, into frequency signals, which are frequency-domain signals. The frequency conversion units 271a, 272a, . . . , and 27Ma convert an acoustic signal into a ⅓-octave band frequency signal using, for example, Fast Fourier Transformation (FFT).

The acoustic energy calculation units 271b, 272b, . . . , and 27Mb calculate acoustic energy in a corresponding azimuth by integrating frequency signals input from the frequency conversion units in the corresponding azimuth among the frequency conversion units 271a, 272a, . . . , and 27Ma.

The acoustic energy comparison unit 27c compares the magnitude of the acoustic energy input from each of the acoustic energy calculation units 271b, 272b, . . . , and 27Mb, and specifies the azimuth in which the maximum acoustic energy is input as the position of the object. Each of the M added acoustic signals S₁, S₂, . . . , S_{M} is filtered to have a strong sound pressure directivity for the corresponding azimuth. Therefore, the large acoustic energy means that there is a sound source in the azimuth. According to the embodiment, it is estimated that the object is in the azimuth in which the maximum acoustic energy is obtained.

In addition, the acoustic energy comparison unit 27c compares the acoustic energy input from each of the acoustic energy calculation units 271b, 272b, . . . , and 27Mb with normal sound data D stored in advance, and thereby can determine the abnormal sound for each azimuth. The normal sound data D is acoustic energy calculated by the acoustic energy calculation units 271b, 272b, . . . , and 27Mb in a case where no abnormal sound occurs at each azimuth. In a case where the difference between the acoustic energy input from each of the acoustic energy calculation units 271b, 272b, . . . , and 27Mb and the normal sound data D is equal to or greater than a threshold, it can be determined that there is an abnormal sound in the azimuth corresponding to the acoustic energy.

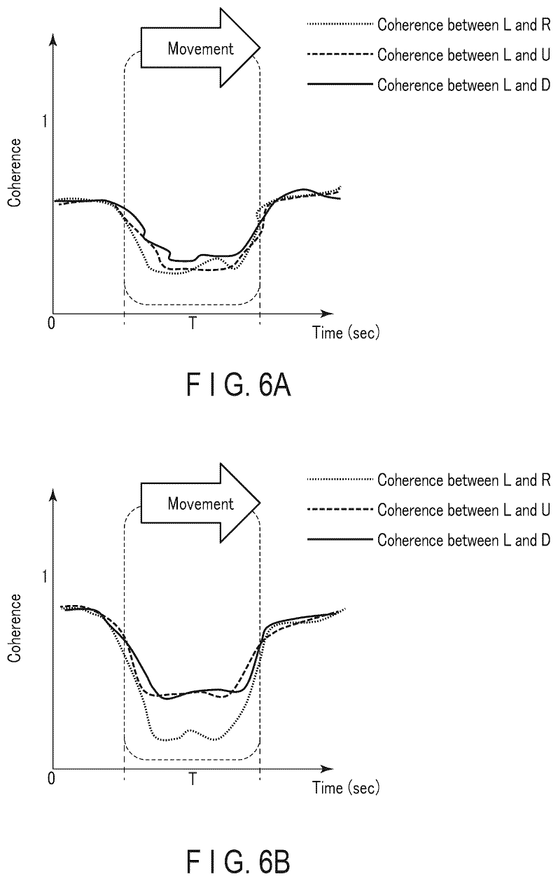

Hereinafter, the disturbance suppression processing according to the first embodiment will be described. In the following description, as shown in FIG. 5, a case where the microphone array 10 includes four microphones 10R, 10U, 10L, and 10D arranged on the circumference at azimuth angles of 0 degrees, 90 degrees, 180 degrees, and 270 degrees will be described as an example. Here, in FIG. 5, there is a sound source SS of the object at the 90-degree azimuth. Furthermore, the microphones 10R, 10U, 10L, and 10D move integrally with the sound source SS of the object, and at this time, a sound source ss that can be a disturbance is generated in the left direction, that is, at the 180-degree azimuth. Further, in the following description, the reference microphone is assumed to be the microphone 10L.

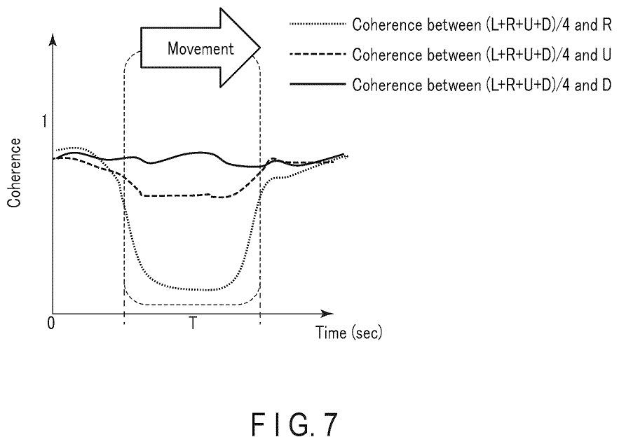

FIG. 6A is a diagram showing a coherence analysis result in an example of a case where the disturbance suppression processing is not performed. The horizontal axis in FIG. 6A represents elapsed time (sec). In FIG. 6A, the sound source SS of the object and the microphones 10R, 10U, 10L, and 10D move in a certain time interval T, and a disturbance occurs during this interval. On the other hand, the vertical axis in FIG. 6A represents average coherence in the 500 Hz to 3 kHz band (⅓ octave band). Coherence is a degree of correlation of acoustic energy calculated from two acoustic signals. Coherence of identical signals indicates a maximum value of one, and coherence of uncorrelated indicates a minimum value of zero. In FIG. 6A, the calculation of coherence is performed without performing the cross-correlation processing as the disturbance suppression processing. Therefore, the coherence between L and R in FIG. 6A is the coherence calculated from the acoustic energy calculated from the acoustic signal of the microphone 10L and the acoustic energy calculated from the acoustic signal of the microphone 10R. Similarly, the coherence between L and U in FIG. 6A is the coherence calculated from the acoustic energy calculated from the acoustic signal of the microphone 10L and the acoustic energy calculated from the acoustic signal of the microphone 10U. Similarly, the coherence between L and D in FIG. 6A is the coherence calculated from the acoustic energy calculated from the acoustic signal of the microphone 10L and the acoustic energy calculated from the acoustic signal of the microphone 10D.

As shown in FIG. 5, since the microphones 10R, 10U, 10L, and 10D are arranged at intervals, in a case where the sound from the sound source SS is small, the same sound does not enter each microphone, and as a result, coherence does not indicate 1 even if there is no disturbance. This is the characteristic of coherence outside the time interval T.

On the other hand, in the time interval T in which the disturbance occurs, the decrease in coherence becomes greater compared with other intervals. This indicates that a change appears in the acoustic signal collected by each microphone due to the disturbance incident on each microphone. As shown in FIG. 6A, the coherence between the microphone 10L and the microphone 10R is further reduced as compared with the coherence between the microphone 10L and the microphone 10U and the coherence between the microphone 10L and the microphone 10D. This is because the disturbance is occurring at the 180-degree azimuth.

FIG. 6B is a diagram showing an analysis result of coherence of an example in a case where the disturbance suppression processing is performed. The horizontal axis and the vertical axis in FIG. 6B are similar to those in FIG. 6A. However, in FIG. 6B, cross-correlation processing as disturbance suppression processing has been performed. Therefore, the coherence between L and R in FIG. 6B is the coherence calculated from the acoustic energy calculated from the cross-correlation signal as a result of the cross-correlation processing on two acoustic signals of the microphone 10L and the acoustic energy calculated from the acoustic signal of the microphone 10R. Similarly, the coherence between L and U in FIG. 6B is the coherence calculated from the acoustic energy calculated from the cross-correlation signal as a result of the cross-correlation processing on two acoustic signals of the microphone 10L and the acoustic energy calculated from the acoustic signal of the microphone 10U. Similarly, the coherence between L and D in FIG. 6B is the coherence calculated from the acoustic energy calculated from the cross-correlation signal as a result of the cross-correlation processing on two acoustic signals of the microphone 10L and the acoustic energy calculated from the acoustic signal of the microphone 10D. For example, the cross-correlation processing on the acoustic signal of the microphone 10L and the acoustic signal of the microphone 10R is represented by the following Equation (2).

$$( {s}_{L} + {n}_{L} ) {( {s}_{R} + {n}_{R} )}^{*} = {s}_{L} {s}_{R}^{*} + {s}_{L} {n}_{R}^{⋆} + {n}_{L} {s}_{R}^{*} + {n}_{L} {n}_{R}^{⋆} = {s}_{L} {s}_{R}^{*} + {n}_{L} {n}_{R}^{⋆} \qquad Equation ( 2 )$$

In Equation (2), s_{L} is a component of the sound source SS of the object in the acoustic signal of the microphone 10L, and n_{L} is a component of the sound source ss of the disturbance in the acoustic signal of the microphone 10L. In addition, s_{R} is a component of the sound source SS of the object in the acoustic signal of the microphone 10R, and n_{R} is a component of the sound source ss of the disturbance in the acoustic signal of the microphone 10R. In addition, * represents a complex conjugate. In Equation (2), the s_{L}n_{R}* term and the n_{L}s_{R}* term out of the four terms on the right side obtained by the cross-correlation processing are removed because they are uncorrelated. The cross-correlation processing on the acoustic signal of the microphone 10L and the acoustic signal of the microphone 10U and the cross-correlation processing on the acoustic signal of the microphone 10L and the acoustic signal of the microphone 10D are also performed in accordance with Equation (2). Then, in the cross-correlation processing between the microphone 10L and the microphone 10U, the s_{L}n_{U}* term and the n_{L}s_{U}* term are removed since they are uncorrelated, and in the cross-correlation processing between the microphone 10L and the microphone 10D, the s_{L}n_{D}* term and the n_{L}s_{D}* term are removed since they are uncorrelated.

As a result, as shown in FIG. 6B, the coherence calculated from the cross-correlation signal as a result of the cross-correlation processing as the disturbance suppression processing is greater than the coherence calculated from the acoustic signal on which the disturbance suppression processing has not been performed. In this manner, the influence of disturbance is suppressed by the cross-correlation processing on the acoustic signals of the two microphones.

Here, according to the embodiment, the reference microphone is fixed to the microphone 10L. With this configuration, the phase difference between the acoustic signal collected by the microphone 10R, the acoustic signal of the microphone 10U, the acoustic signal of the microphone 10L, and the acoustic signal of the microphone 10D is maintained even after the cross-correlation processing. According to the embodiment, the acoustic power minimization control used for the directivity control of the microphone is control for minimizing the acoustic power of the synthesized sound of the microphones by controlling the amplitude and the phase of the acoustic signals collected by the microphones. By maintaining the phase difference between the acoustic signal of the microphone 10U, the acoustic signal of the microphone 10L, and the acoustic signal of the microphone 10D even after the cross-correlation processing, the acoustic filter itself determined based on the gain control law and the acoustic power minimization control law can be used as the acoustic filters 261a, 262a, . . . , and 26Ma.

In the example of FIG. 6B, the reference microphone is microphone 10L. On the other hand, the reference microphone may be any one of the microphone 10R, the microphone 10U, and the microphone 10D. However, from the viewpoint of the level of the effect of the disturbance suppression processing, the reference microphone is desirably the microphone 10L. This is because the microphone 10L is closest to the sound source ss of the disturbance. The effect of the disturbance suppression processing can be enhanced by using the acoustic signal that can most include sound information from the sound source ss of the disturbance as the reference signal of the cross-correlation processing. Therefore, in a case where the position of the sound source of the disturbance is known, the first selection unit 21 can select the microphone closest to the position of the sound source of the disturbance as the reference microphone based on the information on the position of the sound source of the disturbance as the disturbance information and the information on the arrangement of the microphone as the environment information.

Furthermore, in a case where the frequency band of the disturbance sound or the frequency band of the sound of the object is known, in addition to the disturbance suppression processing by the cross-correlation processing described above, the disturbance suppression processing of removing the component of the frequency band of the disturbance sound or removing the component of the frequency band other than the frequency band of the sound of the object from the acoustic signal collected by each microphone can be used.

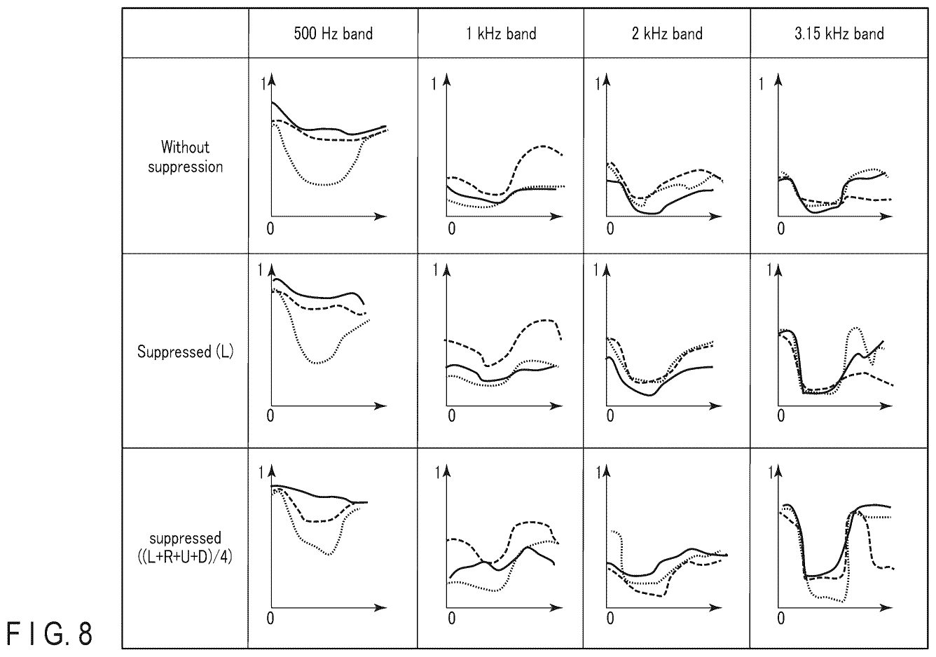

Furthermore, the number of reference microphones is not necessarily one. One or more microphones may be selected as the reference microphone. FIG. 7 is a diagram showing an analysis result of coherence in an example of a case where four reference microphones are selected and the disturbance suppression processing is performed. The horizontal axis and the vertical axis in FIG. 7 are similar to those in FIGS. 6A and 6B. However, in FIG. 7, the microphone 10R, the microphone 10U, the microphone 10L, and the microphone 10D are selected as the reference microphones. Then, cross-correlation processing with a signal obtained by averaging the acoustic signals of the respective microphones is performed. Therefore, the coherence between (L+R+U+D)/4 and R in FIG. 7 is the coherence calculated from the acoustic energy calculated from the cross-correlation signal as a result of the cross-correlation processing between the acoustic signal obtained by averaging the acoustic signals of the microphone 10L, the microphone 10R, the microphone 10U, and the microphone 10D and the acoustic signal of the microphone 10R and the acoustic energy calculated from the acoustic signal of the microphone 10R. Similarly, the coherence between (L+R+U+D)/4 and U in FIG. 7 is the coherence calculated from the acoustic energy calculated from the cross-correlation signal as a result of the cross-correlation processing between the acoustic signal obtained by averaging the acoustic signals of the microphone 10L, the microphone 10R, the microphone 10U, and the microphone 10D and the acoustic signal of the microphone 10U and the acoustic energy calculated from the acoustic signal of the microphone 10U. Similarly, the coherence between (L+R+U+D)/4 and D in FIG. 7 is the coherence calculated from the acoustic energy calculated from the cross-correlation signal as a result of the cross-correlation processing between the acoustic signal obtained by averaging the acoustic signals of the microphone 10L, the microphone 10R, the microphone 10U, and the microphone 10D and the acoustic signal of the microphone 10D and the acoustic energy calculated from the acoustic signal of the microphone 10D.

As shown in FIG. 7, in a case where the four microphones are selected as the reference microphones, coherence is improved particularly in the time interval T in which disturbance occurs. As described above, in particular, in a case where the occurrence position of the disturbance is unknown, the cross-correlation processing is performed using the acoustic signals of all the installed microphones, so that the effect of the disturbance suppression processing is expected to be improved.

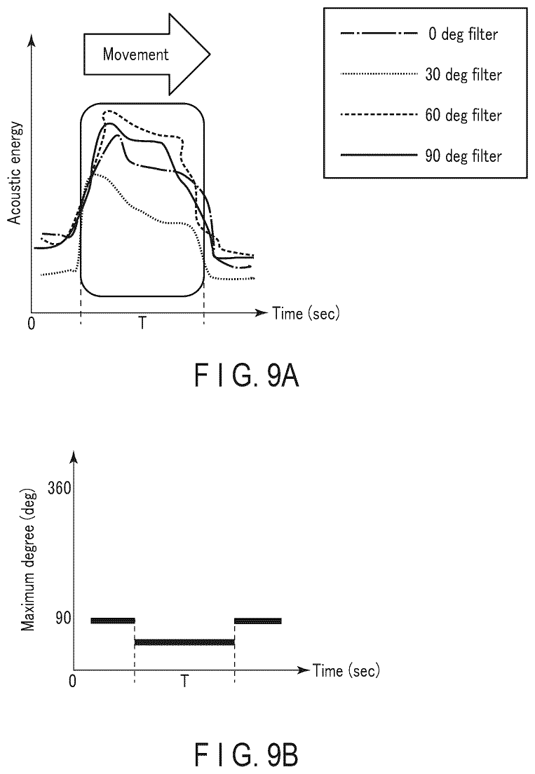

FIG. 8 is a diagram showing an analysis result of the effect of the disturbance suppression processing compared for each frequency band. FIG. 8 illustrates analysis results of a 500 Hz band, a 1 kHz band, a 2 kHz band, and a 3.15 kHz band. As shown in FIG. 8, in the low frequency range, coherence tends to be high regardless of whether or not the disturbance suppression processing has been performed. This is because a standing wave is likely to occur in the low frequency range, and the coherence of the entire space is likely to increase. On the other hand, in the 3.15 kHz band, the component of the sound source becomes large, and the effect of improving coherence by the disturbance suppression processing becomes remarkable. This is because reverberation characteristics that decrease due to wall reflection or the like become dominant in the high range, and the coherence of the sound source itself tends to decrease. Due to the degradation of the sound source's own coherence, in a case where disturbance suppression processing is performed in the initial state of the acoustic signal, the coherence greatly improves. In other words, in a case where the frequency of the sound of the object is high, the effect of the disturbance suppression processing is particularly high.

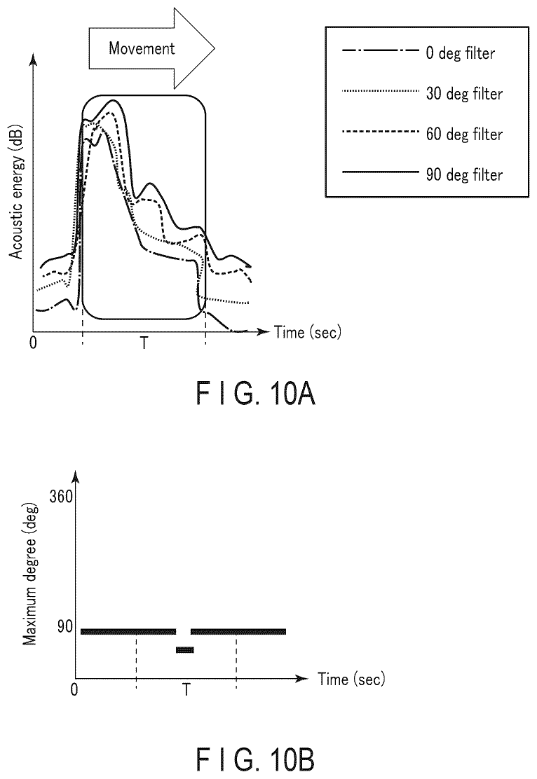

FIG. 9A illustrates a temporal change in an example of the acoustic energy for each azimuth calculated under a condition that the disturbance suppression processing is not performed. FIG. 9B illustrates a temporal change of the estimation result of the position of the object based on the acoustic energy of FIG. 9A. Here, the object exists in the 90-degree azimuth similarly to FIG. 5. Therefore, originally, the position estimation result is always the 90-degree azimuth. However, as shown in FIG. 9A, in the time interval T while the object and the microphone are moving, the azimuth indicating the maximum acoustic energy is the 60-degree azimuth due to the influence of the disturbance. Therefore, as shown in FIG. 9B, the position estimation result in the time interval T also indicates the 60-degree azimuth.

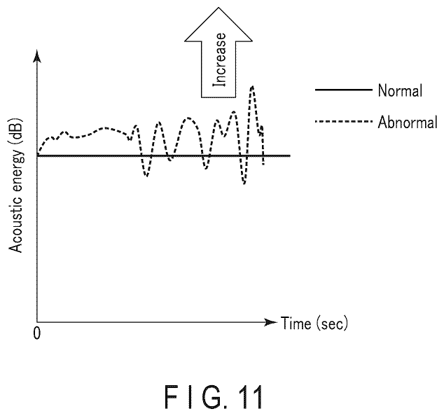

FIG. 10A illustrates a temporal change in an example of the acoustic energy for each azimuth calculated under a condition that the disturbance suppression processing has been performed. FIG. 10B illustrates a temporal change of the estimation result of the position of the object based on the acoustic energy of FIG. 10A. After the disturbance suppression processing, the fluctuation range of the acoustic energy increases as a whole, including the acoustic energy at the time of movement. On the other hand, since only correlated sound for each azimuth is extracted, the azimuth indicating the maximum acoustic energy is the 90-degree azimuth in during the time interval T while the object and the microphone are moving. In this manner, the disturbance sound leading to erroneous estimation is suppressed, and as a result, as shown in FIG. 10B, a correct estimation result of the azimuth is obtained even at the time of movement.

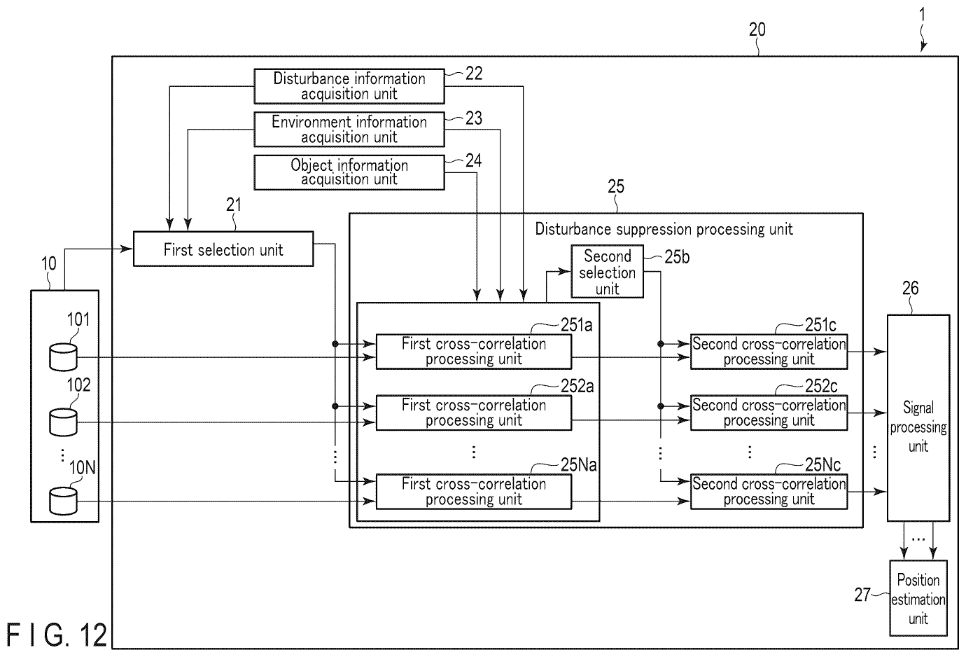

FIG. 11 is a diagram showing a comparison of the level difference of the acoustic energy between the normal state and the abnormal state in a case where the result of FIG. 10A is obtained. It can be seen that the acoustic level fluctuates due to the movement, but increases on average in the abnormal state as compared with the normal state. In this manner, according to the embodiment, the abnormal sound can also be detected by comparing the acoustic energy.

As described above, according to the first embodiment, in the sound collecting apparatus that artificially increases the sound pressure sensitivity in a specific area and artificially decreases the sound pressure sensitivity in an area other than the specific area by applying, to the microphone, the filter control law by the gain control and the acoustic power minimization control using the speaker, the reference microphone is selected from the microphones, the cross-correlation processing is performed on the acoustic signal of the reference microphone and the acoustic signal of each microphone, and the acoustic filter based on the filter control law described above is applied to the acoustic signal subjected to the cross-correlation processing. As a result, the influence of disturbance in the acoustic signal collected by the microphone is suppressed. In this manner, according to the first embodiment, the sound of the object can be collected even in an environment where there is noise around the object. By estimating the position of the object using the acoustic signal in which the influence of such disturbance is suppressed, erroneous estimation of the position is also suppressed.

Furthermore, according to the first embodiment, the cross-correlation processing is performed on the acoustic signal of the reference microphone and the acoustic signals of the respective microphones, so that the phase difference between the respective acoustic signals after the cross-correlation processing is the same as the phase difference of the acoustic signals before the cross-correlation processing. Therefore, as the acoustic filter applied to the acoustic signal, the acoustic filter itself determined based on the gain control law and the acoustic power minimization control law can be used.

Here, according to the first embodiment, the acoustic filters and the adders are provided as many as the number of azimuths to be subjected to position estimation. The azimuth to be subjected to the position estimation in this case may not necessarily correspond to a sound source. In addition, if it is sufficient to be able to collect only a sound in a specific azimuth such as a case of detecting an abnormal sound in an object in a known azimuth, it is sufficient that an acoustic filter and an adder corresponding to the azimuth are provided.

### Second Embodiment

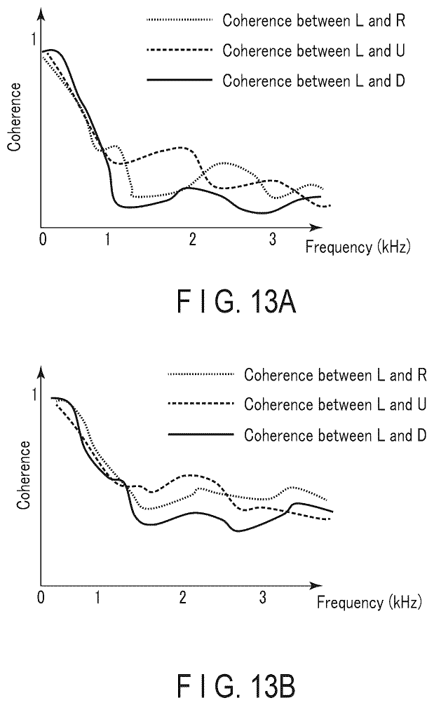

Next, a second embodiment will be described. FIG. 12 is a diagram showing an example of a configuration of a sound collecting apparatus according to the second embodiment. Here, in the second embodiment, the detailed description of the portion same as the first embodiment will be simplified or omitted as appropriate.

As in the first embodiment, a microphone array 10 includes a plurality of microphones 101, 102, . . . , 10N (where N is an integer of two or more) arranged close to each other. The microphones 101, 102, . . . , and 10N are devices that collect surrounding sound and convert the collected sound into an acoustic signal as an electric signal.

A signal processing apparatus 20 performs signal processing on the acoustic signals obtained by the microphones 101, 102, . . . , and 10N, respectively. As in the first embodiment, the signal processing apparatus 20 includes a first selection unit 21, a disturbance information acquisition unit 22, an environment information acquisition unit 23, an object information acquisition unit 24, a disturbance suppression processing unit 25, a signal processing unit 26, and a position estimation unit 27. The second embodiment is different from the first embodiment in the configuration of the disturbance suppression processing unit 25.

The disturbance suppression processing unit 25 performs disturbance suppression processing for suppressing the influence of disturbance in the acoustic signals acquired by the microphones 101, 102, . . . , and 10N based on the acoustic signals acquired by each of the microphones 101, 102, . . . , and 10N and the acoustic signal of the reference microphone acquired by the first selection unit 21. The disturbance suppression processing unit 25 according to the second embodiment includes N first cross-correlation processing units 251a, 252a, . . . , and 25Na, a second selection unit 25b, and N second cross-correlation processing units 251c, 252c, . . . , and 25Nc.

The acoustic signal of the reference microphone selected by the first selection unit 21 and the acoustic signals from the corresponding microphones of the microphones 101, 102, . . . , and 10N are input to the first cross-correlation processing units 251a, 252a, . . . , and 25Na. The first cross-correlation processing units 251a, 252a, . . . , and 25Na output cross-correlation signals that are calculation results of the cross-correlation processing between the two input acoustic signals as acoustic signals after the disturbance suppression processing.

The second selection unit 25b selects a cross-correlation signal between the acoustic signals of the reference microphone from among the cross-correlation signals obtained by the first cross-correlation processing units 251a, 252a, . . . , and 25Na. For example, in a case where the reference microphone is the microphone 101, the second selection unit 25b selects the cross-correlation signal s_{c11} expressed by the following Equation (3).

$${s}_{c 11} = ( {s}_{1} + {n}_{1} ) {( {s}_{1} + {n}_{1} )}^{*} = {s}_{1} {s}_{1}^{*} + {n}_{1} {n}_{1}^{⋆} \qquad Equation ( 3 )$$

The cross-correlation signals between the reference microphones selected by the second selection unit 25b and the cross-correlation signal from the corresponding first cross-correlation processing units among the first cross-correlation processing units 251a, 252a, . . . , and 25Na are input to the second cross-correlation processing units 251c, 252c, . . . , and 25Nc. The second cross-correlation processing units 251c, 252c, . . . , and 25Nc output cross-correlation signals corresponding to cross-correlation results between the two input cross-correlation signals as acoustic signals after the disturbance suppression processing. For example, in a case where the reference microphone is the microphone 101, the second cross-correlation processing units 251c, 252c, . . . , and 25Nc output the cross-correlation signal s_{c2N} expressed by the following Equation (4).

$${S}_{c 2 N} = ( {s}_{1} {s}_{1}^{*} + {n}_{1} {n}_{1}^{⋆} ) {( {s}_{1} {s}_{N}^{*} + {n}_{1} {n}_{N}^{⋆} )}^{*} = ( {s}_{1} {s}_{1}^{*} ) ( {s}_{1} {s}_{N}^{⋆} ) + ( {n}_{1} {n}_{1}^{⋆} ) ( {n}_{1} {n}_{N}^{⋆} ) \qquad Equation ( 4 )$$

As in the first embodiment, the disturbance suppression processing unit 25 can perform the disturbance suppression processing other than the cross-correlation processing based on disturbance information input from the disturbance information acquisition unit 22, environment information input from the environment information acquisition unit 23, and object information input from the object information acquisition unit 24.

The signal processing unit 26 has a configuration similar to that shown in FIG. 3, and performs signal processing for the gain processing and the attenuation processing on the N cross-correlation signals s_{c2N} output from the disturbance suppression processing unit 25 after the disturbance suppression processing.

Hereinafter, the disturbance suppression processing according to the second embodiment will be described. Similarly to the first embodiment, a case where the microphone array 10 includes four microphones 10R, 10U, 10L, and 10D arranged on a circumference at azimuth angles of 0 degrees, 90 degrees, 180 degrees, and 270 degrees as shown in FIG. 5 will be described below as an example. Here, in FIG. 5, there is a sound source SS of the object at the 90-degree azimuth. Furthermore, the microphones 10R, 10U, 10L, and 10D move integrally with the sound source SS of the object, and at this time, a sound source ss that can be a disturbance is generated in the left direction, that is, at the 180-degree azimuth. Further, in the following description, the reference microphone is assumed to be the microphone 10L.

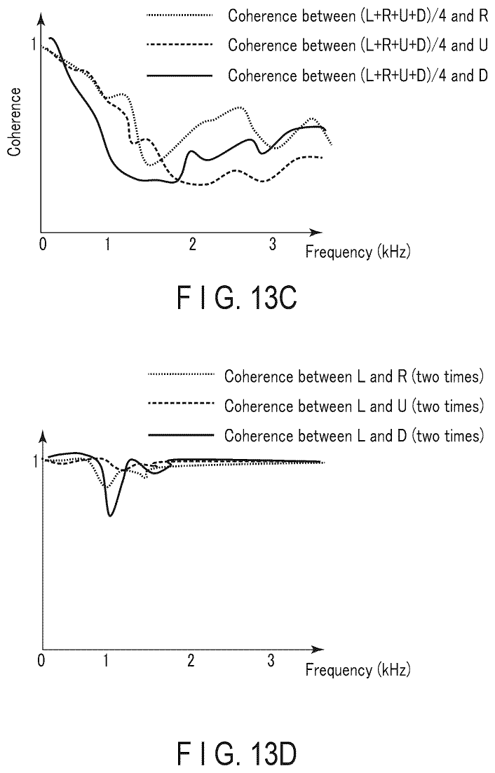

FIG. 13A is a diagram showing an analysis result of coherence in an example of a case where the disturbance suppression processing is not performed. FIG. 13B is a diagram showing an analysis result of coherence in an example of a case where the disturbance suppression processing including one cross-correlation process is performed. FIG. 13C is a diagram showing an analysis result of coherence in an example of a case where the disturbance suppression processing including one cross-correlation process is performed where the microphones 10R, 10U, 10L, and 10D are set as reference microphones. FIG. 13D is a diagram showing an analysis result of coherence in an example of a case where the disturbance suppression processing including two cross-correlation processes is performed. The horizontal axis in FIGS. 13A, 13B, 13C, and 13D represents the frequency (kHz). Further, the vertical axis in FIGS. 13A, 13B, 13C, and 13D represents coherence.

As is clear from the comparison of FIGS. 13A, 13B, 13C, and 13D, the coherence can be improved by the two cross-correlation processes regardless of the frequency.

As described above, according to the second embodiment, the cross-correlation processing is performed on the acoustic signal of the reference microphone and the acoustic signal of each microphone, the cross-correlation processing is further performed on the cross-correlation signal between the acoustic signals of the reference microphone and the cross-correlation signal between the acoustic signal of the reference microphone and each acoustic signal, and the acoustic filter based on the filter control law described above is applied to the cross-correlated acoustic signal. As a result, the influence of disturbance on the acoustic signals collected by the microphones is further suppressed. By estimating the position of the object using the acoustic signal in which the influence of such disturbance is suppressed, erroneous estimation of the position is also suppressed.

Furthermore, also in the second embodiment, in the second cross-correlation processing, the cross-correlation signal between the reference microphones is fixed, and the cross-correlation processing with another cross-correlation signal is performed, so that the phase difference between the respective acoustic signals after the cross-correlation processing is the same as the phase difference of the acoustic signal before the cross-correlation processing. Therefore, as the acoustic filter applied to the acoustic signal, the acoustic filter itself determined based on the gain control law and the acoustic power minimization control law can be used.

### Modification

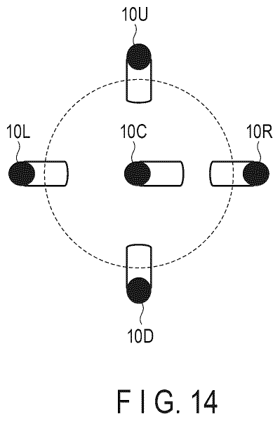

Modifications of the first embodiment and the second embodiment will be described below. According to the first embodiment and the second embodiment, the microphone array 10 can be four microphones 10R, 10U, 10L, and 10D arranged on the circumference at 90-degree intervals, for example, at azimuth angles of 0 degrees, 90 degrees, 180 degrees, and 270 degrees as shown in FIG. 2. With such an arrangement, near-omnidirectionality can be obtained. On the other hand, the number of microphones for obtaining the near-omnidirectionality is not limited to four, as long as an even number. Furthermore, the orientation of the microphones constituting the microphone array 10 is not limited to the outward orientation, and may be inward. However, the distance between the center of the circle and each microphone surface is desirably equal. Furthermore, in a case where the number of microphones is an odd number by installing one microphone at the center of the circle as in the microphone 10C in FIG. 14, even if the number of microphones constituting the microphone array 10 is an odd number, near-omnidirectionality can be obtained.

Further, the microphones 101, 102, . . . , 10N constituting the microphone array 10 may be installed on the same plane. In other words, the direction in which the microphone array 10 is installed is not necessarily a plane parallel to the ground surface, and may be a plane perpendicular to the ground surface.

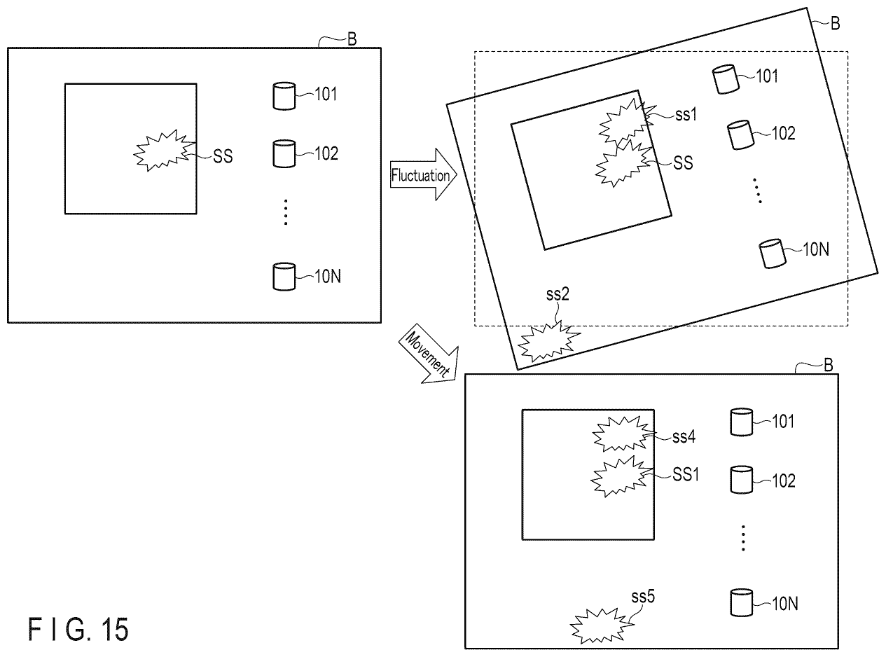

Furthermore, as described in the first embodiment and the second embodiment, in a case where the object and the microphone are in the same space, as shown in FIG. 15, in a case where the space fluctuates due to vibration or the like, or in a case where the space moves, a new noise may be generated even if the relative position between the object and the microphone does not change. For example, in the example of FIG. 15, a situation is assumed in which a sound source SS that emits a sound as an object and microphones 101, 102, . . . , and 10N are stationary in space B. In FIG. 15, noises ss1 and ss2 are generated by the fluctuation of the space B from the stationary situation, and noises ss4 and ss5 are generated by the fluctuation of the space B from the stationary situation.

As described above, the position of the sound source may be different from that at the time of stopping due to the fluctuation or movement of the space B. Here, in a case where the noises ss1, ss2, ss4, and ss5 are processed as disturbances, the disturbance suppression processing described in the first embodiment and the second embodiment can be applied. On the other hand, in order to make the noises ss1, ss2, ss4, and ss5 also the position estimation target, it is necessary to prevent the noises ss1, ss2, ss4, and ss5 from being processed as disturbance. Therefore, in the modification, the characteristic of the acoustic energy in a case where the space B is stopped is measured in advance or between fluctuations and movements, and a microphone with a small fluctuation in the acoustic energy is selected as the reference microphone. By selecting a microphone having no variation in acoustic energy as the reference microphone, the effect of the disturbance suppression processing on the noises ss1, ss2, ss4, and ss5 can be reduced.

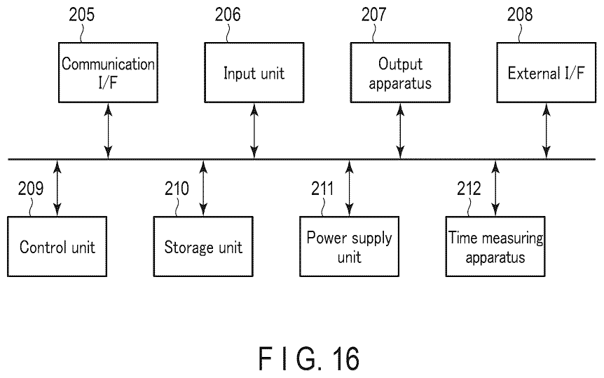

Next, an example of a hardware configuration of the sound collecting apparatus 1 described in each of the above-described embodiments will be described with reference to FIG. 16. FIG. 16 is a diagram showing an example of a hardware configuration of the sound collecting apparatus 1.

As shown in FIG. 16, the sound collecting apparatus includes a computer to which a control unit 209, a storage unit 210, a power supply unit 211, a time measuring apparatus 212, a communication interface (I/F) 205, an input unit 206, an output apparatus 207, and an external interface (I/F) 208 are electrically connected.

The control unit 209 includes a Central Processing Unit (CPU), a Random Access Memory (RAM), a Read Only Memory (ROM), and/or the like, and controls each component according to information processing. The control unit 209 can operate as the signal processing apparatus 20. The control unit 209 can execute processing by calling an execution program stored in the storage unit 210.

The storage unit 210 is a medium that stores information such as a program so as to be readable by a computer, a machine, and the like. The storage unit 210 can store the normal sound data D and the like. The storage unit 210 can be, for example, an auxiliary storage device such as a hard disk drive or a solid-state drive. Furthermore, the storage unit 210 may include a drive. The drive is a device for reading data stored in another auxiliary storage device, a recording medium, or the like, and includes, for example, a semiconductor memory drive (flash memory drive), a compact disk (CD) drive, a digital versatile disk (DVD) drive, or the like. The type of the drive may be appropriately selected according to the type of the storage medium.

The power supply unit 211 supplies power to each element of the sound collecting apparatus 1. The power supply unit 211 may further supply power to each element of equipment including the sound collecting apparatus 1. The power supply unit 211 can include, for example, a secondary battery or an AC power supply.

The time measuring apparatus 212 is an apparatus that measures time. For example, the time measuring apparatus 212 may be a clock including a calendar, and passes current year, month, and/or date and time information to the control unit 209. The time measuring apparatus 212 may be used in a case of adding date and time to an acoustic signal to be collected.

The communication interface 205 is, for example, a near field communication (for example, Bluetooth (registered trademark)) module, a wired local area network (LAN) module, a wireless LAN module, or the like, and is an interface for performing wired or wireless communication via a network. Communication via this network may be wireless or wired. Note that the network may be an internetwork including the Internet, or may be another type of network such as an in-house LAN. Furthermore, the communication interface 205 may perform one-to-one communication using a Universal Serial Bus (USB) cable or the like. Further, the communication interface 205 may include a micro USB connector. The communication interface 205 is an interface for connecting to an external device such as various communication devices. The communication interface 205 is controlled by the control unit 209, and receives various types of information from an external device via a network or the like. The various types of information include, for example, the disturbance information, the environment information, and the object information set in an external device.

The input unit 206 is a device that receives an input, and may be, for example, a touch panel, a physical button, a mouse, a keyboard, or the like. Furthermore, the input unit 206 includes a microphone array 10. The output apparatus 207 is a device that performs output, and is, for example, a display, a speaker, or the like that outputs information by display, voice, or the like. The disturbance information, the environment information, and the object information may be input via the input unit 206.

The external interface 208 is for mediating between the main body of the sound collecting apparatus and the external apparatus. The external apparatus may be, for example, a printer, a memory, a communication device, or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sound collecting apparatus comprising a processor that comprises hardware configured to:
select one or more of two or more microphones as a reference microphone;
acquire a first acoustic signal from the reference microphone;
perform disturbance suppression processing including cross-correlation processing between the first acoustic signal and a second acoustic signal acquired from each of the microphones;
apply an acoustic filter to disturbance-suppressed acoustic signals from the respective microphones to impart sound pressure directivity toward a preset azimuth among a plurality of azimuths;
add the acoustic signals to which the acoustic filter is applied; and
output added acoustic signals that are obtained by the addition and are corresponding to the azimuths, respectively.

2. The sound collecting apparatus according to claim 1, wherein
the processor selects the reference microphone based on information about a disturbance other than an object that is a sound collection target of the microphones.

3. The sound collecting apparatus according to claim 1, wherein
the processor selects, as the reference microphone, a microphone having a small variation in acoustic energy calculated from each of the microphones.

4. The sound collecting apparatus according to claim 1, wherein
the processor
selects two or more of the microphones as the reference microphones, and
acquires, as the first acoustic signal, an acoustic signal obtained by averaging acoustic signals from the respective reference microphones.

5. The sound collecting apparatus according to claim 1, wherein
the processor is further configured to
select a first cross-correlation signal obtained by cross-correlation processing between the first acoustic signal from the reference microphone and the second acoustic signal from the reference microphone, and
perform disturbance suppression processing including cross-correlation processing between the first cross-correlation signal and a second cross-correlation signal obtained by cross-correlation processing between the first acoustic signal and the second acoustic signal from each of the microphones.

6. The sound collecting apparatus according to claim 1, wherein
the microphones are an even number of microphones arranged on a circumference.

7. A non-transitory computer-readable storage medium storing a sound collection program for causing the processor to:
select one or more of two or more microphones as a reference microphone;
acquire a first acoustic signal from the reference microphone;
perform disturbance suppression processing including cross-correlation processing between the first acoustic signal and a second acoustic signal acquired from each of the microphones;
apply an acoustic filter to disturbance-suppressed acoustic signals from the respective microphones to impart sound pressure directivity toward a preset azimuth among a plurality of azimuths;
add the acoustic signals to which the acoustic filter is applied; and
output added acoustic signals that are obtained by the addition and are corresponding to the azimuths, respectively.

8. A sound collecting method comprising:
select one or more of two or more microphones as a reference microphone;
acquire a first acoustic signal from the reference microphone;
perform disturbance suppression processing including cross-correlation processing between the first acoustic signal and a second acoustic signal acquired from each of the microphones;
apply an acoustic filter to disturbance-suppressed acoustic signals from the respective microphones to impart sound pressure directivity toward a preset azimuth among a plurality of azimuths;
add the acoustic signals to which the acoustic filter is applied; and
output added acoustic signals that are obtained by the addition and are corresponding to the azimuths, respectively.
